(19) United States
(12) Patent Application Publication
(10) Pub. No.: US 2013/0169881 A1
(43) Pub. Date: Jul. 4, 2013

(54) VIDEO/BROADCAST DATA RECEIVING SYSTEM

(71) Applicant: Tokuji KANO, Kanagawa-ken (JP)

(72) Inventor: Tokuji KANO, Kanagawa-ken (JP)

(73) Assignee: KABUSHIKI KAISHA TOSHIBA, Tokyo (JP)

(21) Appl. No.: 13/601,741

(22) Filed: Aug. 31, 2012

(30) Foreign Application Priority Data
Dec. 28, 2011 (JP) 2011-288804

(51) Int. Cl. H04N 5/268

(52) U.S. Cl. 348/706; 348/E05.057

(57) ABSTRACT

According to one embodiment, an image display device includes a first receiving unit to receive a first broadcast signal through a first communication line, a second receiving unit to receive a second broadcast signal through a second communication line, a data matching unit to detect a data quality of the first and second broadcast signals, a decision unit that generates a selection signal based on the data quality of the first and second broadcast signals, and a switching unit that transmits the selection signals to an image processing unit which processes the selection signal, wherein the selection signal is based on the first and second broadcast signal.

### CROSS-REFERENCE TO RELATED APPLICATION

This application is based upon and claims the benefit of priority from Japanese Patent Application No. 2011-288804, filed Dec. 28, 2011, the entire contents of which are incorporated herein by reference.

### FIELD

Embodiments described herein relate to image receiving devices.

### BACKGROUND

In recent years, transmission through digital systems brought about digital broadcasts. Digital broadcasts in Japan adopt the ISDB-T system. In the ISDB-T system, signal processes such as error-correction coding, interleaving coding, and digital modulation are applied to TS (Transport Stream) which is regulated by MPEG (Moving Picture Expert Group) 2 standards. Additionally, OFDM (Orthogonal Frequency Division Multiplexing) modulation is applied before output.

There are streaming programs as well. IP broadcasts are digital broadcasts using the Internet Protocol (IP). In an IP broadcast, digital broadcast contents are IP packetized and transmitted through the Internet (the IP network).

In a television receiver that is capable of receiving general digital broadcasts and IP broadcasts, an antenna is used to receive television broadcast signals transmitted through radio waves and a network port, such as a LAN (Local Area Network) port, is used to receive television broadcast signals transmitted through the IP network. By switching between antenna input and network input, displayed contents can be switched after being received by the antenna or the network port.

Viewers are able to view identical contents by receiving broadcast signals transmitted through different routes. This benefits the viewers by providing a variety of selections.

However, when viewing identical contents, the viewer needs to make a choice as to which among the two broadcast signals to receive as their input, which may be troublesome.

### DESCRIPTION OF THE DRAWINGS

FIG. 1 is a block diagram of a data receiving device, according to Embodiment 1.

FIG. 2 is an example block diagram of a stable-data estimation unit within FIG. 1.

FIG. 3 is an example block diagram of a data matching unit within FIG. 1.

FIG. 4 is an example block diagram of a switching unit within FIG. 1.

FIG. 5 is a flow chart explaining the movement of the embodiment.

FIGS. 6A to 6I are explanatory drawings of demodulator 13.

FIG. 7 is a block diagram of the data matching unit, according to Embodiment 2.

### DETAILED DESCRIPTION

In general, the drawings provided are used to further explain the embodiments of the image receiving system in detail.

According to an embodiment, there is provided an image receiving device that automatically selects input based on data quality to eliminate complicated selection operations by the users.

The embodiment of the data receiving device includes: a first receiving unit to receive a first broadcast signal through a first designated channel, a second receiving unit to receive a second broadcast signal identical with the first broadcast signal transmitted through a second communication line, a data matching unit to detect a data quality of the first and second broadcast signals, a decision unit that generates a selection signal based on the data quality of the first and second broadcast signals determined by the data matching unit, and a switching unit that transmits the selection signal to an image processing unit which processes the selection signal, wherein the selection signal is based on the first and second broadcast signal

### Embodiment 1

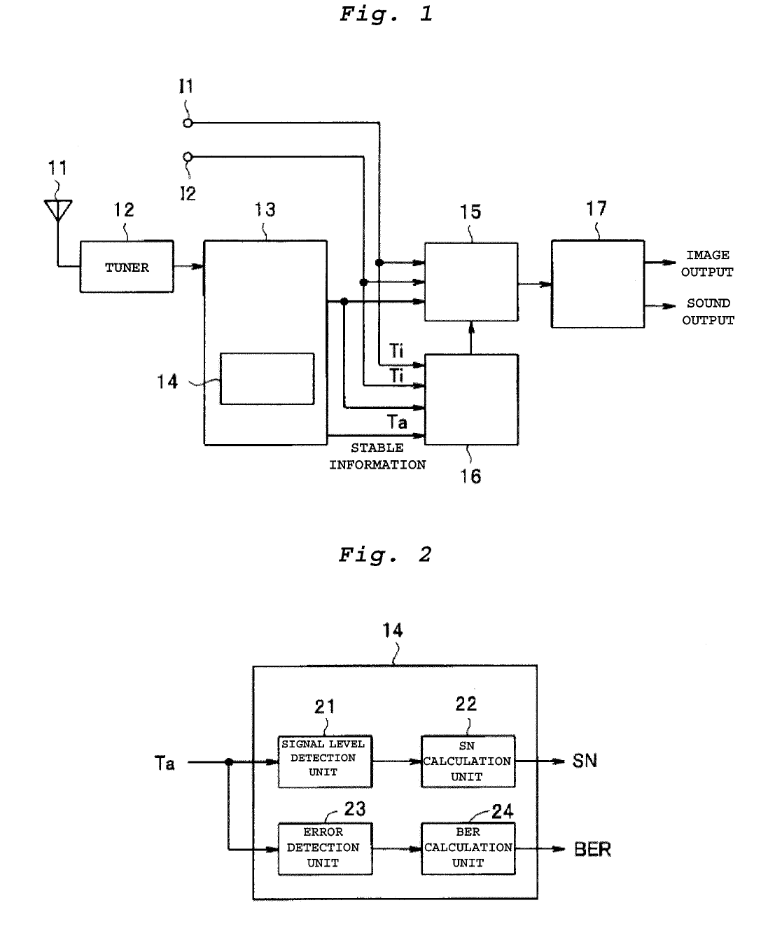

FIG. 1 is the block diagram of the data receiving device according to Embodiment 1.

In FIG. 1, antenna 11 receives digital broadcast signals. Network ports I1, I2 are each connected to a network interface such as wired LAN or wireless LAN in which IP packetized digital broadcast signals are input. A digital broadcast signal received by antenna 11 and digital broadcast signal received through network ports I1, I2 are identical in content and are received at almost an identical time.

A digital broadcast signal received by antenna 11 is sent to tuner 12. Tuner 12 tunes channels based on the tuning operation done by the user. The tuned broadcast signal is output to demodulator 13. Demodulator 13 quadrature detects the tuned broadcast signal to obtain the OFDM signal of the baseband. Demodulator 13 eliminates the guard interval from the baseband OFDM signal. By FFT (Fast Fourier Transformation) processing, the demodulator 13 transforms the time domain OFDM signal to the frequency domain OFDM symbol.

Demodulator 13 can restore original data from the OFDM symbol. For example, each sub carrier of the OFDM symbol is either modulated by PSK (phase-shift keying) modulation or QAM (quadrature amplitude modulation). Demodulator 13 applies an appropriate demodulation process based on the modulation to restore original data. Demodulator 13 also applies a reverse process including an inner code process and outer code process of the error-correction process applied to the demodulation signal by the sender to restore the transport stream transmitted by the OFDM signal. Demodulator 13 sends the restored transport stream Ta to switching unit 15 and data matching unit 16.

The server that provides broadcast signals through the network (image not provided) IP packetizes the transport stream of the broadcast signal to transmit to the network (image not provided). Furthermore, this network is a network capable of communicating through an IP protocol such as the internet.

This type of server may place a time stamp on the transport stream, then IP packetize the transport stream to transmit through the network. The server may transcode the video/sound codec within the transport stream as well.

IP packetized broadcast signals are a transport stream which is transmitted through the network (image not provided) and de-packetized through an interface, such as LAN, and later to be input to network port I1 and/or I2. This transport stream Ti is sent to switching unit 15 and data matching unit 16.

If switching unit 15 selects output from demodulator 13, the broadcast signal is transmitted through antenna 11 and the transport stream Ta will be selected and sent to sound/image processing unit 17. If switching unit 15 selects output from network port I1 or I2, the broadcast signal is transmitted through the network, and transport stream Ti will be selected and sent to sound/image processing unit 17.

The transport stream supports many programs (channels). During decryption, the sound/image processing unit 17 is able to select the desired program packet of the time-sharing multiple programs. Because of this selection, the transport stream (TS) packet header attaches a PID, which is an ID to distinguish different packets. Transport stream packets are multiplexed with table information including PID lists of the program composition such as video and audio known as PMT (Program Map Table) or PAT (Program Association Table).

To extract the desired program packet, sound/image processing unit 17 searches through PAT and PMT packets and extracts the desired video data and audio data packet. Sound/image processing unit 17 decodes the extracted packet to gain image output and sound output. The sound/image processing unit 17 issues the image output and sound output to the monitor (image not provided) allowing viewing of the designated contents.

According to an embodiment, data matching unit 16 controls the selection process of the switching unit 15. The switching unit allows automatic selection of the viewer desired contents transmitted through the route requested by the viewer.

To enable this selection, demodulator 13 includes a stable-data estimation unit 14. Information gained during the demodulation process of demodulator 13 such as clock shift information, carrier shift information, transmission parameters, signal level, and error signal information is input to stable-data estimation unit 14. Based on these input data, the stable-data estimation unit 14 evaluates the broadcast-signal data quality transmitted through radio waves, and outputs the evaluation results, which are the stable data, to the data matching unit 16.

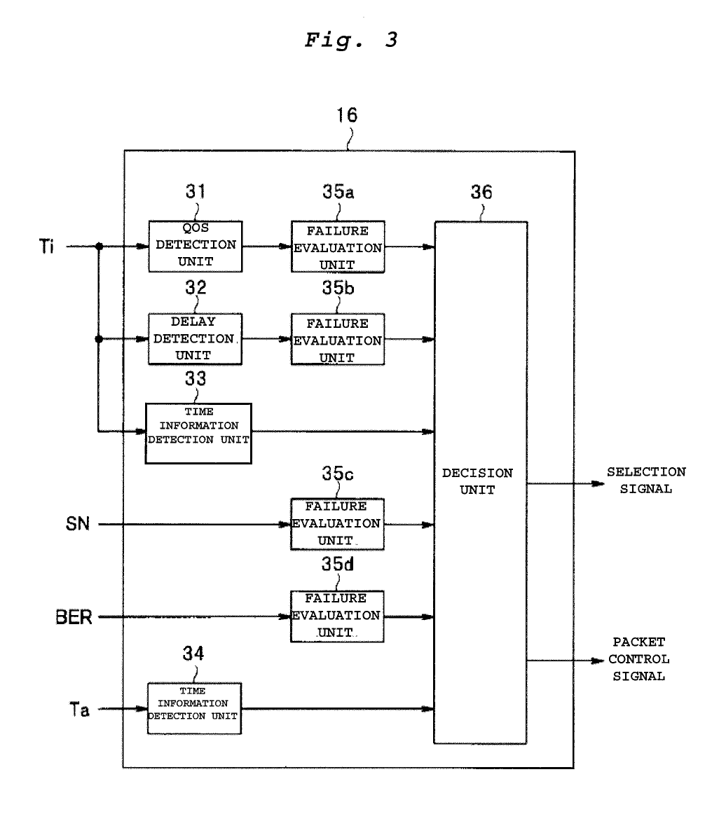

FIG. 2 is a detailed structure of stable-data estimation unit 14 within FIG. 1. As an example, this is a block diagram representing the circuit structure when using SN (Signal to Noise Ratio) and BER (Bit Error Rate) for data quality evaluation. Signal-level detection unit 21 detects the signal level and noise level of the received signal and outputs to the SN calculation unit 22. SN calculation unit 22 calculates the SN of the received signal, then outputs the calculation result as stable data to data matching unit 16.

Error detection unit 23 detects the bit error of the received signal to output to the BER calculation unit 24. BER calculation unit 24 calculates the BER of the received signal, and outputs the calculation result as stable data to data matching unit 16. In this manner, stable-data estimation unit 14 issues stable information (which represents the data quality of the broadcast signal transmitted through radio waves) to data matching unit 16.

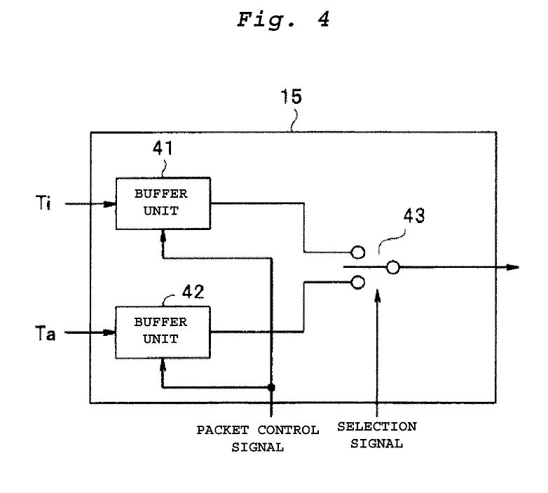

FIG. 3 is a block diagram of an example of the detailed structure of data matching unit 16 within FIG. 1. Transport stream Ti coming through network port I1 or I2 is sent to QOS detection unit 31 as well as delay detection unit 32. QOS detection unit 31 detects QOS (Quality of Service) of data received through the network and outputs the detection result to failure evaluation unit 35a. Delay detection unit 32 detects the amount of delay in the data received through the network and outputs the detection result to failure evaluation unit 35b. Failure evaluation units 35c and 35d are each sent SN or BER from data estimation unit 14, as illustrated in FIG. 2.

To evaluate broadcast signal transmitted through the network as a failure or not, failure evaluation units 35a, 35b are each set with a threshold value for QOS or amount of delay. By comparing each input QOS or amount of delay with the threshold value, failure evaluation unit 35a, 35b outputs the evaluation result as a failure or not to decision unit 36.

Similarly, to determine broadcast signals transmitted through the radio waves as a failure or not, failure evaluation units 35c, 35d are each set with a threshold value for SN or BER. By comparing each input SN or BER with the threshold value, failure evaluation units 35c, 35d output the evaluation result as a failure, or not, to decision unit 36.

Transport stream Ti that comes through network port I1 or I2 is sent to time information detection unit 33. Transport stream Ta that comes from demodulator 13 is sent to time information detection unit 34. Time information such as the stream time standard and decoding playback process time standard are inserted into the transport stream. Time information detection units 33, 34 detect time information within the input stream and output the detection result to decision unit 36.

Decision unit 36 is given the results from failure evaluation units 35a to 35d. Of the broadcast signal transmitted through the network (communication line) and broadcast signal transmitted through radio waves, a selection signal is generated to select the broadcast signal that is not evaluated as a failure based on the evaluation result. The selection signal is then output to switching unit 15.

During the selection of broadcast signal switching, in order to have playback frames that are continuous before and after the switching, decision unit 36 outputs time information from time information detection units 33, 34 as packet control signals to switching unit 15 to designate the packet as continuous before switching.

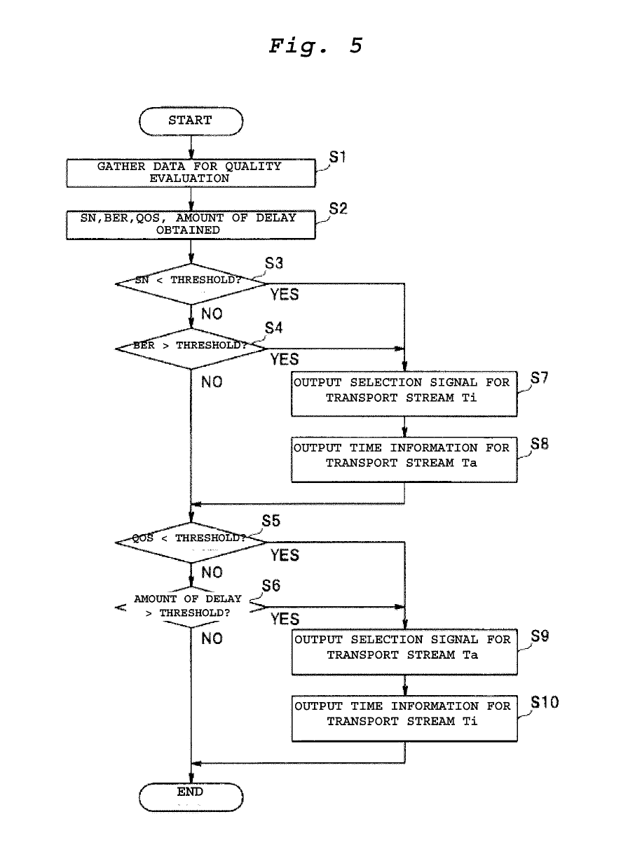

FIG. 4 is a block diagram of an example of the detailed structure of switching unit 15 within FIG. 1. Transport stream Ti that comes through network port I1 or I2 is sent to buffer unit 41 and saved. Transport stream Ta that comes through demodulator 13 is sent to buffer unit 42 and saved. Buffer units 41, 42 sequentially output all packets on and after the packet designated by the packet control signal to switch 43. Switch 43 is controlled by the selection signal. Transport stream Ti or Ta saved on buffer units 41, 42 is selectively output to sound/image processing unit 17 using switch 43.

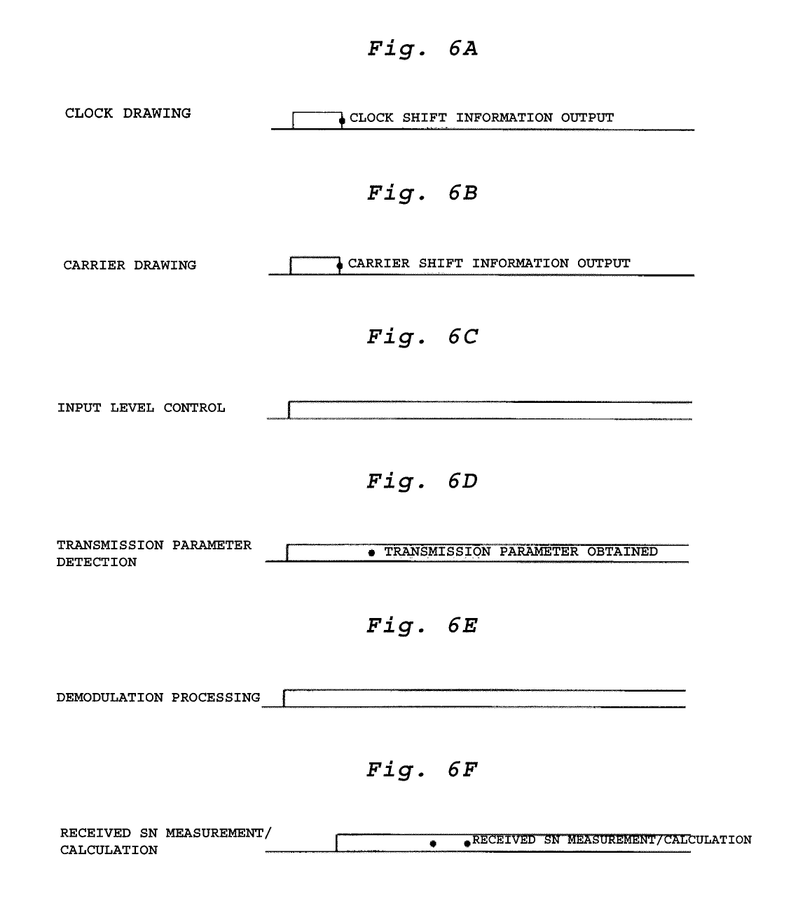

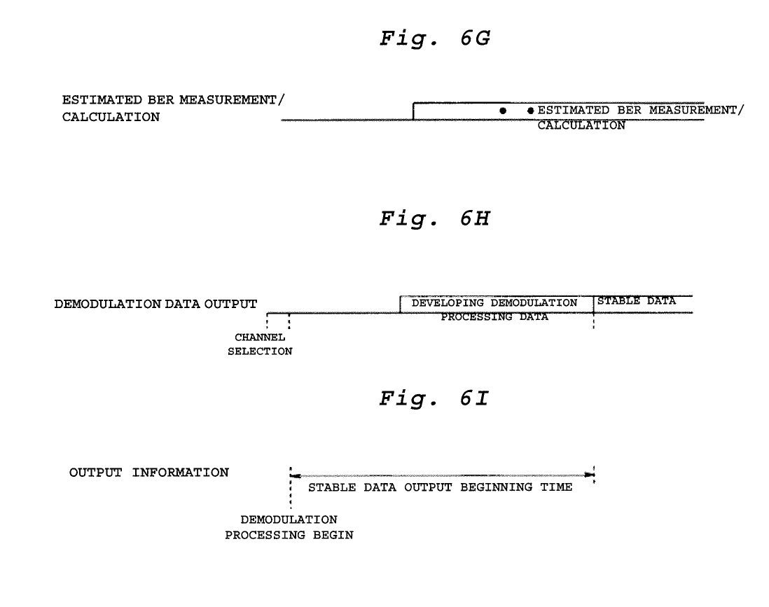

Next, an embodiment will be explained using FIG. 5 and FIGS. 6A to 6I. FIG. 5 is a flow chart to explain the aspects of an embodiment. FIGS. 6A to 6I are explanatory drawings of processes of the demodulator 13.

Antenna 11 receives broadcast signals transmitted through radio waves. Broadcast signals transmitted through the communication line are input to network ports hand 12. Contents provided through these broadcast signals are identical. Although the broadcast signals may contain some delay, they are received at almost identical times. In the initial condition, the image receiving system may be set to viewing contents from either the broadcast signals transmitted through radio waves or the broadcast signals transmitted through the network.

Broadcast signals received by antenna 11 can be tuned with tuner 12 of FIG. 1, demodulated by demodulator 13, and outputs as transport stream Ta. De-packetized transport stream Ti is input to network port I1 or I2. These transport streams Ta, Ti are sent to switching unit 15 and data matching unit 16.

For this embodiment, stable-data estimation unit 14 provided in demodulator 13 obtains the quality of broadcasted data transmitted through radio waves to output stable information. Stable-data estimation unit 14 obtains various information relating to the demodulation process of demodulator 13. FIGS. 6A to 6I explain the timing of each process of the demodulator 13. FIGS. 6A to 6I show process times of each process, a black circle represents the timing at which information is obtained and the output timing during the process.

After tuning, demodulator 13 begins the demodulation process, in accordance with the clock drawing and carrier drawing (FIG. 6A and FIG. 6B). During this process, clock shift information and carrier shift information is obtained. As shown in FIG. 6C to FIG. 6E, along with the demodulation process, input level control and transmission parameter detection process are performed simultaneously from the start time of the demodulation process. This is how the transmission parameter is obtained.

When clock synchronization and carrier synchronization are established, as FIG. 6F shows, received SN is calculated based on the receiving level measurement result. Next, based on the received error, estimated BER is calculated (FIG. 6G). After a fixed time has passed since the start of the demodulation process, transport stream Ta, is output. Demodulation is unstable at the initial demodulation output stage. During the time as shown in FIG. 6H, demodulation output is still unstable, developing demodulation process data. When the stable data output beginning time has passed after the demodulation process begins, stable demodulation output (stable data) is output.

Stable-data estimation unit 14 gathers data for quality evaluation as illustrated in FIG. 5, step S1. At step S2, the stable-data estimation unit 14 requests information such as received SN and estimated BER as shown in FIG. 6F and FIG. 6G. The stable-data estimation unit 14 outputs stable information to data matching unit 16.

Transport stream Ti input to network port 11 or I2 is sent to data matching unit 16. QOS detection unit 31 and delay detection unit 32 within data matching unit 16 calculates the QOS and the amount of delay based on transport stream Ti (step S2).

In FIG. 5, at steps S3 to S6, failure evaluation units 35c, 35d, 35a, 35b each evaluate whether the data quality is associated with a failure or not, and then outputs the evaluation result to decision unit 36. For example, failure evaluation unit 35c evaluates whether the input SN is less than the designated threshold value. At step S3, if the SN is less than the threshold value, decision unit 36 will decide that the data quality of the broadcast signal transmitted through radio waves are degraded, and will output a selection signal to select the broadcast signal transmitted through the network, namely, transport stream Ti (step S7).

Similarly, failure evaluation unit 35d evaluates whether the input BER is greater than the designated threshold value. At step S4, if the BER is greater than the threshold value, decision unit 36 will decide that the data quality of the broadcast signal transmitted through radio waves is degraded, and will output a selection signal to select the broadcast signal transmitted through the network, namely, transport stream Ti (step S7).

After step S7, decision unit 36 will additionally output time information of transport stream Ta (which is selected before the transport stream switching) as a packet control signal (step S8).

Failure evaluation unit 35a evaluates whether the input QOS is less than the designated threshold value. At step S5, if the QOS is less than the threshold value, decision unit 36 will decide that the data quality of the broadcast signal transmitted through the network is degraded, and will output a selection signal to select the broadcast signal transmitted through radio waves, namely, transport stream Ta (step S9).

Similarly, failure evaluation unit 35b evaluates whether the input amount of delay is greater than the designated threshold value. At step S6, if the amount of delay is greater than the threshold value, decision unit 36 will decide that the data quality of the broadcast signals transmitted through the network are degraded, and will output a selection signal to select the broadcast signal transmitted through radio waves, namely, transport stream Ta (Step S9).

After step S9, decision unit 36 will additionally output time information of transport stream Ti (which is selected before the transport stream switching) as a packet control signal (step S10).

Transport streams Ti and Ta are each saved onto buffer units 41 and 42 within the switching unit 15. Buffer units 41 and 42 sequentially read through packets based on the packet control signal. By doing so, a continuous frame display is shown with continuous packet reading.

Transport streams Ti and Ta from buffer units 41 and 42 are sent to switch 43. Based on the selection signal, one of the transport streams is selected to be sent to the sound/image processing unit 17. Sound/image processing unit 17 generates an image signal and sound signal based on the transport stream to be sent to the monitor (image not provided). Thus, on the monitor display screen, user-specified contents based on broadcast signals that are not degraded in data quality are automatically selected to be displayed.

Thus, according to an embodiment, when identical contents of the broadcast signals are transmitted through plural transmission routes, data quality through each transmission route is detected and transport streams are selected to be displayed based on broadcast signals that are not degraded in data quality. The viewer is able to view contents based on broadcast signals with non-degraded data quality without performing complicated operations. Even when poor weather conditions cause data quality degradation of broadcast signals through radio waves, or when an increase in network traffic causes data quality degradation to broadcast signals through the network, viewers do not need to perform a complicated operation such as choosing between the currently viewed contents and other contents and manually selecting the better quality content. Instead, transport streams in which data quality has not dropped are automatically selected to be viewed. Additionally, when switching inputs, packet selection is done so that the display frame is continuous, and image quality does not drop during this process.

### Embodiment 2

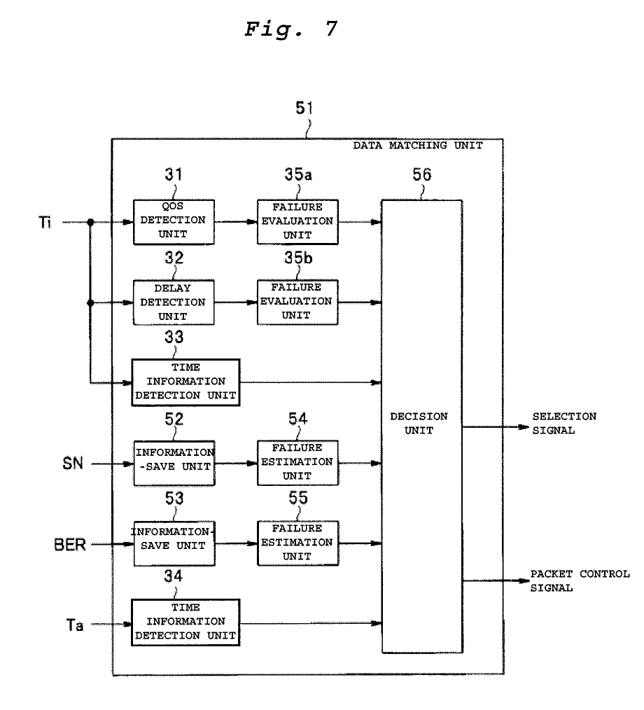

FIG. 7 is a block diagram of a data matching unit 51 to be adopted for Embodiment 2. In FIG. 7, for structure elements identical to those of FIG. 3, explanation will be omitted and identical letters or numerals will be used. As illustrated in FIG. 7, the data matching unit structure is the only difference from the image receiving device in FIG. 3.

In Embodiment 1, whether there is a reception failure or not is evaluated by comparing the threshold value with stable information (which represents data quality). When evaluated as a failure, the input method is switched. However, depending on the threshold setting, the data quality may decline considerably and there is a possibility of the input being switched after the screen display has been degraded. According to an aspect, a log record of the stable data which represents data quality can be used to make a prediction of data quality degradation before switching input.

In FIG. 7, stable-data estimation unit 14 (refer to FIG. 1) issues SN and BER to information-save units 52 and 53. Information-save units 52 and 53 both save the input SN or BER and also output the save log to failure estimation units 54 and 55.

Failure estimation unit 54 is given the received SN log from information-save unit 52. Failure estimation unit 54 estimates a change in received SN based on the log and estimates the timing at which received SN becomes less than the threshold value. Additionally, failure estimation unit 55 is given the BER log from information-save unit 53. Failure estimation unit 55 estimates the change in BER based on the log, and estimates the timing at which BER becomes greater than the threshold value. Estimation results of failure estimation units 54, 55 are sent to decision unit 56.

Decision unit 56 is given the evaluation results from failure evaluation units 35a, 35b and estimation results of failure estimation units 54, 55. Of the broadcast signal transmitted through the network (communication line) and broadcast signal transmitted through radio waves, a selection signal is generated to select the broadcast signal having sufficient signal strength to provide a desired play quality not evaluated as a failure based on the evaluation result or a broadcast signal not estimated as a failure based on the estimation result, which is then output to switching unit 15. Additionally, during the selection of broadcast signal switching, in order to have playback frames that are continuous before and after the switching, decision unit 56 outputs a packet control signal to switching unit 15, similar to decision unit 36 in FIG. 3.

Next, a structured embodiment will be explained.

According to an aspect, the viewer is viewing the contents of broadcast signals input to network port I1 or I2. Then, the data quality of the broadcast signal is degraded due to an increase in network traffic. QOS detection unit 31 and delay detection unit 32 within data matching unit 51 will produce the detection results. Based on those results, failure evaluation units 35a, 35b evaluate that data quality has degraded and will output the evaluation result to decision unit 56. From this, decision unit 56 outputs a selection signal to select the broadcast signal transmitted through radio waves, namely, transport stream Ta to switching unit 15 for packets hereafter. This enables a viewing of contents with a good data quality broadcast signal received through antenna 11 thereafter.

Now, the viewer is viewing the contents of broadcast signals received by antenna 11. Due to poor weather, for example, the data quality of broadcast signals through radio waves becomes unstable. Information-save unit 52, 53 within data matching unit 51 saves the received SN and estimated BER and these logs are output to failure estimation units 54 and 55.

Failure estimation units 54, 55 make an estimate of how received SN and BER will change based on the received SN and BER log. Failure estimation units 54, 55 make estimates of the timing of when the received SN and BER will exceed the threshold value. The estimation result of failure estimation units 54, 55 is sent to decision unit 56.

Based on the estimation result of failure estimation units 54, 55, if the decision unit 56 evaluates that, after a designated time, the data quality of broadcast signals through antenna 11 will degrade, it outputs a selection signal to select the transport stream Ti (broadcast signal received through the network before this time) to switching unit 15. By doing this, while the data quality of the broadcast signal received through antenna 11 is good, it will be switched with contents of a good data quality broadcast signal received through the network. This enables switching input without a drop in data quality while the viewer looks at the contents in good receiving conditions.

In this embodiment, data quality failure timing is estimated and input switching is done to maintain good receiving conditions without a decline in data quality, to continue viewing in this manner.

In this embodiment, data matching unit 51 estimating the change in the received SN and BER is used as an example for explanation purposes. Based on various types of information shown in FIGS. 6A to 6I, making an estimate of the timing of degradation of the receiving condition is also possible. Additionally, data matching unit 51 is able to make an estimate of the timing as to when a stable receiving condition is obtained with various types of information from FIGS. 6A to 6I.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display device comprising:
a first receiving unit to receive a first broadcast signal through a first communication line;
a second receiving unit to receive a second broadcast signal through a second communication line, wherein the second broadcast signal is identical with the first broadcast signal;
a data matching unit to detect a data quality of the first and second broadcast signals;
a decision unit that generates a selection signal based on the data quality of the first and second broadcast signals determined by the data matching unit; and
a switching unit that transmits the selection signal to an image processing unit which processes the selection signal, wherein the selection signal is based on the first and second broadcast signal.

2. The image display device of claim 1, wherein the first broadcast signal is received through radio waves.

3. The image display device of claim 1, wherein the second broadcast signal is received through an Internet Protocol (IP) network.

4. The image display device of claim 1, wherein the decision unit generates the selection signal using detection results from one or more detection units to determine whether or not to switch broadcast signals based on signal quality of the first and second broadcast signals.

5. The image display device of claim 1, wherein detecting the data quality by the data matching unit includes detecting at least one of a signal-to-noise ratio, an error rate, a transmission quality information and an amount of delay of the first and second broadcast signals.

6. The image display device of claim 1, wherein the switching unit contains one or more save units to save the first and second broadcast channels.

7. The image display device of claim 1, further comprising:
a time information detection unit that detects time information contained within the first and second broadcast signals.

8. The image display device of claim 7, wherein
the switching unit maintains continuity while switching between the first and second broadcast signals by using the detected time information.

9. The image display device of claim 1, wherein the decision unit generates the selection signal to switch the broadcast signal before the data quality drops.

10. The image display device of claim 9, wherein the decision unit generates a selection signal to switch the broadcast signal before the data quality drops by estimating a time of when the data quality of the first and second broadcast signals will drop based on the detection result produced by the data matching unit.

11. A method for operating an image display device comprising:
receiving a first broadcast signal through a first communication line;
receiving a second broadcast signal through a second communication line, wherein the second broadcast signal is identical with the first broadcast signal;
detecting a data quality of the first and second broadcast signals;
generating a selection signal based on the data quality of the first and second broadcast signals; and
transmitting the selection signal to an image processing unit which processes the selection signal, wherein the selection signal is based on the first and second broadcast signal.

12. The method of claim 11, wherein the first broadcast signal is received through radio waves.

13. The method of claim 11, wherein the second broadcast signal is received through an Internet Protocol (IP) network.

14. The method of claim 11, wherein generating the selection signal includes determining whether or not to switch broadcast signals based on signal quality of the first and second broadcast signals.

15. The method of claim 11, wherein detecting the data quality includes detecting at least one of a signal-to-noise ratio, an error rate, a transmission quality information and an amount of delay of the first and second broadcast signals.

16. The method of claim 11, further comprising:
saving the first and second broadcast channels.

17. The method claim 11, further comprising:
detecting time information contained within the first and second broadcast signals.

18. The method of claim 17, further comprising:
maintaining continuity while switching between the first and second broadcast signals by using the detected time information.

19. The method of claim 11, further comprising switching the broadcast signal before the data quality drops.

20. The method of claim 19, wherein switching the broadcast signal before the data quality drops include estimating a time of when the data quality of the first and second broadcast signals will drop based on the detection result produced by the data matching unit.
